(19) United States
(12) Patent Application Publication
(10) Pub. No.: US 2020/0112535 A1
(43) Pub. Date: Apr. 9, 2020

(54) MULTIPLE AD HOC COMMUNICATION NETWORK CREATION AND MANAGEMENT

(71) Applicant: Avaya Inc., Santa Clara, CA (US)

(72) Inventors: Jibin George, Pune (IN); Salil Dhawan, Pune (IN); Sandeep Goynar, Pune (IN); Harsimran Jeet Singh, Pune (IN)

(21) Appl. No.: 16/151,486

(22) Filed: Oct. 4, 2018

(51) Int. Cl. H04L 12/58; G06Q 50/00; G06Q 30/00

(52) U.S. Cl. CPC H04L 51/38; G06Q 30/016; H04L 51/16; G06Q 50/01

(57) ABSTRACT

Communication networks comprise two or more nodes and a communication infrastructure facilitating communication therebetween. Systems and methods are provided that enable a message to be created in one network, by a first node, and endorsed by at least one second node, to allow a new network topology to be created whereby a third node may communicate individual, via manual and/or automated agents, with each of the first and second nodes, any one or more of the first and second nodes may utilize a different network and/or a different communication protocol.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communication networks and particularly to communicating with ad hoc network nodes.

### BACKGROUND

Communication networks may be created for a variety of purposes. Nodes in a communication network, especially an ad hoc network, may be present to participate in some communications and then disconnect from the network and, as a result, be excluded from other communications.

### SUMMARY

Customer satisfaction/dissatisfaction in today's time can make/break businesses. With so many communication channels available, such as those that utilize in whole or in part social media channels, are available to the customers. A missed communication may be viewed as an unpleasant service imparted by a company, which may further lead to negative feedback directed to a company's product and/or the company as a whole.

Social media channels, such as Twitter, Facebook to name a few, are some of the primary and readily accessible (often available with a single click) medium available to the customers to show their happiness, or unhappiness, with the service imparted to them by a business. Feedback, whether positive or negative, placed on a social media channel may be viewed by large number of users in a small duration of time and may be further shared, may form a near endless chain of views to additional users (nodes) on a social media(s) network.

The problem gets compounded when people reading such post reply back as a comment to this post with similar experiences (which they may have been experienced recently or may have occurred to them in the past). As a result, such replies to a single person's complaint originally can extend in unproportionate number of negative comments by different people in a short span of time.

This has the risk of developing a negative perception about company's product and/or the company as a whole, which may lead to hesitation by perspective new customers, existing customers losing trust, and, potentially, a loss of revenue.

A prompt and appropriate action may be required to reduce the damage to goodwill and revenue by addressing the pain-point of, not only the customer who initiated the original comment, but also of the customers who have replied with the similar grievances.

To address the above issues and provide other benefits to advance the state of the art, embodiments are disclosed, including:

A customer puts grievance against the company on social media channel such as Facebook or Twitter. As is often the case with negative comments, each grievance attracts more comments from other users, as well as those who view top level post. A responding company may put forward a generic reply, at least initially, which is of little use to the customer. Agents may create and post manual replies to each customer's comments on one to one basis. Addressing grievances in this one-on-one manner is cumbersome, often lacks consistency, and time and other resource intensive. Additionally, the customer posting a grievance has to come back to the same channel where one has originally commented to check if a response, such as a solution to a problem, has been posted.

These and other needs are addressed by the various embodiments and configurations of the present invention. The embodiments can provide a number of advantages depending on the particular configuration. These and other advantages will be apparent from the disclosure of the invention(s) contained herein.

An original interaction starts with one of the social platforms (e.g., Facebook, Twitter, etc.) There can be a lot of follow-up comments or replies to the original post. Time taken to solve issues varies based on the complexity of the issue. It is common that an issue posted will not receive a prompt reply. A poster may return to find no reply or never return to view a reply that has been posted. Even with notification mechanism, customers may miss the notification due to message management whereby to many messages are either never received, received and discarded (e.g., automatically routed to a “spam” folder), or simply missed or ignored. This is one example of a many-to-one interaction. A group of customers (a “many”) communicating to the same contact center that is, or acts on behalf of a company, (a “one”) for the similar issue. The contact center often tries to reach the customer who created the main post via a different channel, often due to the need to collect additional details in order to resolve a complex issue. Accordingly, this change to a “one-to-one,” where the contact center communicates with the poster of the main post, is a channel change from the many-to-one. The one-to-one is commonly via voice, email, or other two-party communication channel. Reaching out to the individual promotes customer confidence. However, the secondary commenters (those that share, comment on, repost, etc. from the original main post) also need to be notified about the solution.

After the initial post is placed on the social platform, the target contact center reaches out directly to the customer via a convenient channel and resolves the customer's issue. For example, for an initial post originally posted on Facebook, the contact center may have an agent interact with the customer via a voice interaction, such as to gather additional information, clarify issues, and have the customer apply resolutions. Social media interaction may have, or be assigned, a social media interaction identifier which may be presented on a computer display of the agent performing the voice interaction with the customer. Similarly, the voice interaction may have, or be assigned, a voice identifier and associated with the social media interaction identifier.

Once the issue gets resolved, the solution is routed through a workflow to determine whether the answer should be published. One type of workflow can be to include a back-office expert, which may be human-aided in one embodiment, or machine (e.g., computer with a microprocessor executing instructions) in another embodiment, to decide the nature of the solution and determine whether the solution should be published to other customers who are having the same or similar issues. For example, by looking at the solution, the back-office experts can determine whether the problem is generic, or otherwise applicable to more than just the originating customer, and relevant to customers having the same or similar issues that identified as those who posted similar content on one or more social media platforms. However, if the solution is to a specific issue related to the customer who posted the original post, as determined by the back-office expert, then the solution may be omitted from publication.

If the workflow determines the response should be published, the answer, or a form of the answer, may be generated and presented to devices on a network, such as by generating and sending a text message, email, synthetic voice message, and/or presenting text on an agent's terminal for use in a voice call. The same context identifier and notifier unit defined in the diagram will get the notification once the interaction between customer (who has put primary comment) and agent is resolved.

From a collection of similar comments, users having similar issues may be grouped into units having a common context identifier. Users who have commented with different context are grouped separately. Then these groups are notified by the ‘Resolution Notifier Unit’. For each of the customers, if their profile is already known, then a known preferred channel of the customer is identified and utilized as a preferred channel subgroup, which is formed by the controller and may be grouped, or further sub-grouped, by the channel. A channel may have an automated agent that is triggered and, in response, initiates communications to the associated group of customers. Customers are then contacted and the solution is communicated accordingly. Here multichannel or channel specific bots may be used for reaching to the customers. For example, an outbound dialer may be used for reaching all the customers who have preferred channel as voice. Once the call is picked up by the customer, the solution or an abstract of the solution is presented by an automated agent which may be accompanied by context of the call (e.g., what the call is regarding, the business entity involved, the person the automated agent is addressing the call to, date/time the issue was posted, etc.). If the customer profile is not known, then the same channel (e.g., the social media platform that received the initial post) will be utilized as the initial channel and the solution will be communicated individually thereon. For example, if an initial interaction started on Facebook, then customers can be communicated through the Facebook private message service.

Generally, when there is a change in the channel, from many-to-one to one-to-one, and an agent solves the issue originating on the many-to-one channel, then automated agents may access a reply and communicate with each of the identified customers on the many-to-one platform via their preferred or default channel.

In one embodiment, a system for conducting communications via a plurality of networks is disclosed, comprising: a network interface to at least one network; and a microprocessor having a memory for storage of instructions that cause the microprocessor to: receiving, from a first user communication device of a first user, a first message on a first communication channel; receiving, from a second user communication device of a second user, a second message in response to the first message, the second message endorsing the content of the first message; determining a candidate resolution to the first message; connecting a resource to a third communication device of the first user and providing the candidate resolution via a second communication channel; and upon determining the candidate resolution resolved an issue presented in the first message, generating a final resolution from the candidate resolution for a third communication channel and causing a communication agent to connect via the third communication channel to deliver the final resolution to a fourth communication device of the second user.

In another embodiment, a method for conducting communications via a plurality of networks is disclosed, comprising: receiving, from a first user communication device of a first user, a first message on a first communication channel; receiving, from a second user communication device of a second user, a second message in response to the first message, the second message endorsing the content of the first message; determining a candidate resolution to the first message; connecting a resource to a third communication device of the first user and providing the candidate resolution via a second communication channel; and upon determining the candidate resolution resolved an issue presented in the first message, generating a final resolution from the candidate resolution for a third communication channel and causing a communication agent to connect via the third communication channel to deliver the final resolution to a fourth communication device of the second user.

In another embodiment, a server is disclosed, comprising: a network interface to at least one network; and a microprocessor having a memory for storage of instructions that cause the microprocessor to: monitor a message thread on a social media website; determine a message on the message thread comprises an issue relevant to a domain of interest and was posted by a root user; determining a second message on the message thread endorses the content of the message and was posted by a secondary user; connecting a resource to a first communication device of the root user for a first communication; and upon determining the first communication comprises a candidate resolution to an issue in the message, automatically and without human intervention, formatting a final resolution in accordance with the candidate resolution protocol and further in accordance with a communication channel associated with a secondary communication device associated with the secondary user and communicating the final resolution to the secondary device via the communication channel.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall rover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a first process in accordance with embodiments of the present disclosure;

FIG. 4 depicts a second process in accordance with embodiments of the present disclosure;

FIG. 5 depicts a network topology change in accordance with embodiments of the present disclosure;

FIG. 6 depicts a first network topology in accordance with embodiments of the present disclosure; and

FIG. 7 depicts a second network topology in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

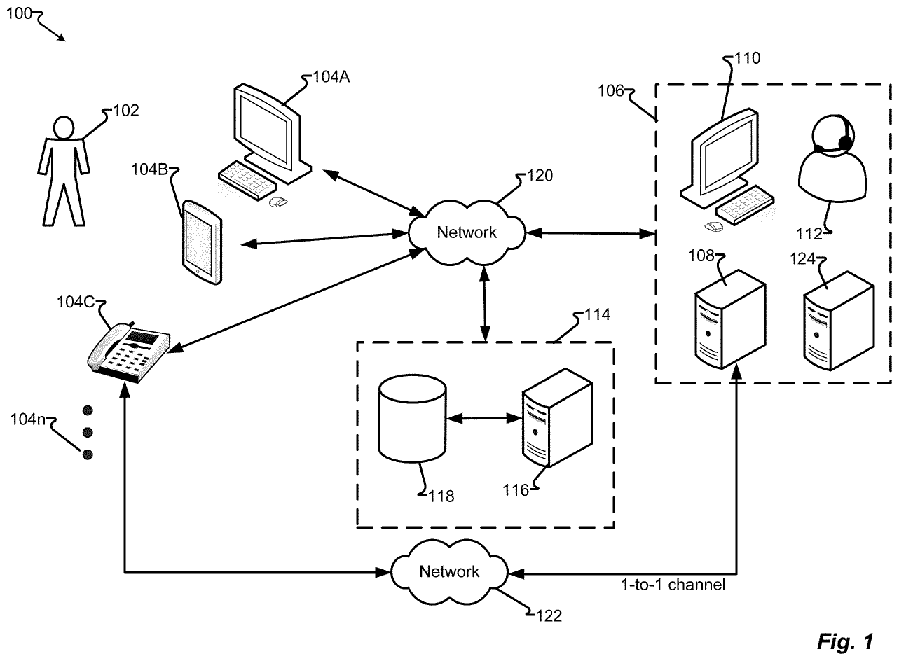

FIG. 1 depicts system 100 in accordance with embodiments of the present disclosure. In one embodiment, user 102 has a number of customer communication devices 104 (e.g., customer communication device 104A-n). Certain devices, such as customer communication device 104A (e.g., computer) and customer communication device 104B (e.g., smart phone) may be capable of conducting communications via a plurality of networks (e.g., WiFi network, ethernet, plain old telephone system (POTS), cellular telephony, Internet, WAN, LAN, Bluetooth, nearfield, infrared, etc.) which may comprise unique and/or overlapping hardware as the physical layer (e.g., OSI physical layer) and/or other media layer differences (OSI Network and/or data link) may be utilize hardware, or hardware configurations, specific components to support one form of communication and which cannot support another, and/or communication protocols (e.g., simple messaging system (SMS), email, VoiP, text/audio/video chat, etc.), such as differences in one or more of OSI levels 7-4 (application, presentation, session, and transport). User 102 may also utilize single network, single protocol devices, such when customer communication device 104C embodied as an analog, POTS telephone.

While embodiments described herein disclose contacting user 102 via different networks, it should be appreciated that, in one embodiment, (e.g., customer communication device 104A-B), the same physical device is utilized for both communications, whereas in another embodiment different physical devices (e.g., two or more of customer communication devices 104A-n) are utilized, each supporting a communication protocol utilized that is not supported by another physical device. For example, customer communication device 104A for HTML-based chat, such as by posting on social media website 114, a first channel utilizing a first protocol, may be contacted by contact center 106 via POTS telephone, which may comprise a different network from network 120 (as discussed more completely below) and a different customer communication device 104, such as POTS telephone customer communication device 104C. Alternatively, contact center 106 may contact user 102 via POTS network via customer which comprise customer communication device 104A, a computer having POTS network connectivity (e.g., network interface card/chip, physical connection, microphone, speaker, etc.).

In one embodiment, user 102 interacts with social media website 114, which comprises at least social media server 118 and social media server 116, via first communication network 120 via customer communication device 104, when configured to interact with social media website 114. Social media website 114 is the hub of a first network topology whereby user 102 and other users communicate, with all communications therebetween passing through social media website 114. For example, contact center 106 may determine that a message is addressed to them and communicate with user 102 such as by posting a response on social media website 114.

In another embodiment, other users (e.g., additional users 102, contact center 106) that wish to communicate with user 102 must utilize social media website 114 to do so via the first network configuration as illustrated. Accordingly, a many-to-one network topology is provided.

In another embodiment, contact center 106 may create an ad hoc network whereby contact center 106 communicates with user 102 in a one-to-one network topology, such as via second network 122. For example, first communication network 120 may be a packet-switched data network (e.g., Internet) and second network 122 may be a POTS telephony network.

Contact center 106 may utilize data processing server 124 to perform data processing tasks, which may include receiving a data feed, such as via an application programming interface (API) or other communication link to social media server 118 directly or via social media server 116 or other component of 114. As a result data processing server 124 may obtain post from users, including user 102, on social media website 114 and determine if such posts are relevant to contact center 106, such as if data processing server 124 identifies a key word or phrase that is maintained in a data repository of relevant key words or phrases and, if so, trigger a response from agent terminal 110 or automated agent 108.

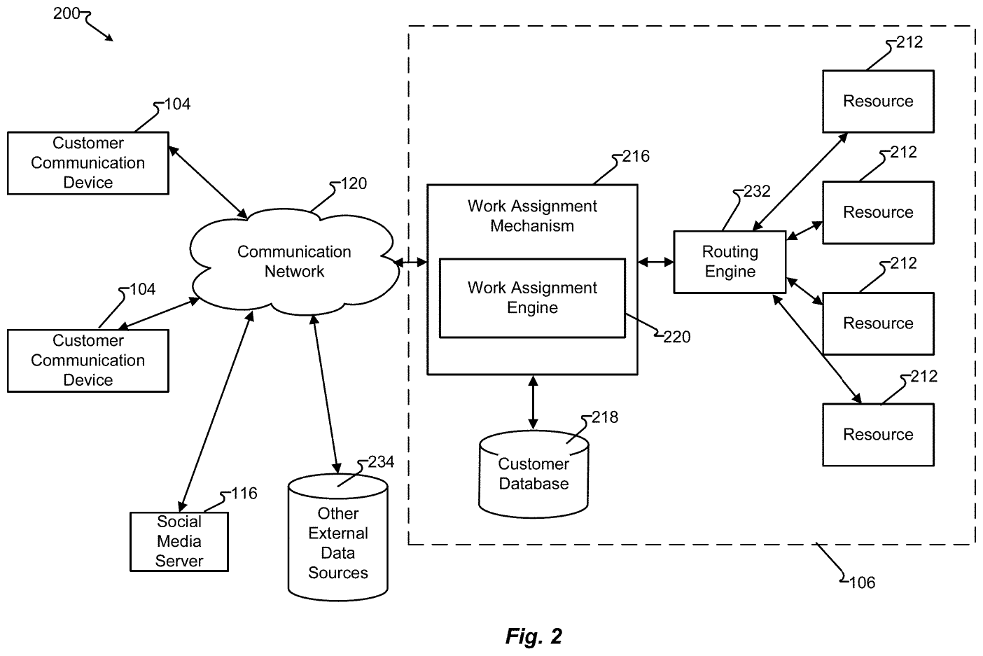

With reference now to FIG. 2, communication system 200 is discussed in accordance with at least some embodiments of the present disclosure. The communication system 200 may be a distributed system and, in some embodiments, comprises a first communication network 120 connecting one or more communication devices 104 to a work assignment mechanism 216, which may be owned and operated by an enterprise administering contact center 106 in which a plurality of resources 212 is distributed to handle incoming work items (in the form of contacts) from customer communication devices 104.

Contact center 106 is variously embodied to receive and/or send messages that are or are associated with work items and the processing and management (e.g., scheduling, assigning, routing, generating, accounting, receiving, monitoring, reviewing, etc.) of the work items by one or more resources 212. The work items are generally generated and/or received requests for a processing resource 212 embodied as, or a component of, an electronic and/or electromagnetically conveyed message. Contact center 106 may include more or fewer components than illustrated and/or provide more or fewer services than illustrated. The border indicating contact center 106 may be a physical boundary (e.g., a building, campus, etc.), legal boundary (e.g., company, enterprise, etc.), and/or logical boundary (e.g., resources 212 utilized to provide services to customers for a customer of contact center 106).

Furthermore, the border illustrating contact center 106 may be as-illustrated or, in other embodiments, include alterations and/or more and/or fewer components than illustrated. For example, in other embodiments, one or more of resources 212, customer database 218, and/or other component may connect to routing engine 232 via first communication network 120, such as when such components connect via a public network (e.g., Internet). In another embodiment, first communication network 120 may be a private utilization of, at least in part, a public network (e.g., VPN); a private network located, at least partially, within contact center 106; or a mixture of private and public networks that may be utilized to provide electronic communication of components described herein. Additionally, it should be appreciated that components illustrated as external, such as social media server 116 and/or other external data sources 234 may be within contact center 106 physically and/or logically, but still be considered external for other purposes. For example, contact center 106 may operate social media server 116 (e.g., a website operable to receive user messages from customers and/or resources 212) as one means to interact with customers via their customer communication device 104.

Customer communication devices 104 are embodied as external to contact center 106 as they are under the more direct control of their respective user or customer. However, embodiments may be provided whereby one or more customer communication devices 104 are physically and/or logically located within contact center 106 and are still considered external to contact center 106, such as when a customer utilizes customer communication device 104 at a kiosk and attaches to a private network of contact center 106 (e.g., WiFi connection to a kiosk, etc.), within or controlled by contact center 106.

It should be appreciated that the description of contact center 106 provides at least one embodiment whereby the following embodiments may be more readily understood without limiting such embodiments. Contact center 106 may be further altered, added to, and/or subtracted from without departing from the scope of any embodiment described herein and without limiting the scope of the embodiments or claims, except as expressly provided.

Additionally, contact center 106 may incorporate and/or utilize social media website 116 and/or other external data sources 234 may be utilized to provide one means for a resource 212 to receive and/or retrieve contacts and connect to a customer of a contact center 106. Other external data sources 234 may include data sources, such as service bureaus, third-party data providers (e.g., credit agencies, public and/or private records, etc.). Customers may utilize their respective customer communication device 104 to send/receive communications utilizing social media server 116.

In accordance with at least some embodiments of the present disclosure, the first communication network 120 may comprise any type of known communication medium or collection of communication media and may use any type of protocols to transport electronic messages between endpoints. The first communication network 120 may include wired and/or wireless communication technologies. The Internet is an example of the first communication network 120 that constitutes an Internet Protocol (IP) network consisting of many computers, computing networks, and other communication devices located all over the world, which are connected through many telephone systems and other means. Other examples of the first communication network 120 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the first communication network 120 need not be limited to any one network type and instead may be comprised of a number of different networks and/or network types. As one example, embodiments of the present disclosure may be utilized to increase the efficiency of a grid-based contact center 106. Examples of a grid-based contact center 106 are more fully described in U.S. Patent Publication No. 2010/0296417 to Steiner, the entire contents of which are hereby incorporated herein by reference. Moreover, the first communication network 120 may comprise a number of different communication media, such as coaxial cable, copper cable/wire, fiber-optic cable, antennas for transmitting/receiving wireless messages, and combinations thereof.

The communication devices 104 may correspond to customer communication devices. In accordance with at least some embodiments of the present disclosure, a customer may utilize their communication device 104 to initiate a work item. Illustrative work items include, but are not limited to, a contact directed toward and received at a contact center 106, a web page request directed toward and received at a server farm (e.g., collection of servers), a media request, an application request (e.g., a request for application resources location on a remote application server, such as a SIP application server), and the like. The work item may be in the form of a message or collection of messages transmitted over the first communication network 120. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 216, but rather may be on some other server in the first communication network 120 where it is harvested by the work assignment mechanism 216, which generates a work item for the harvested communication, such as social media server 116. An example of such a harvested communication includes a social media communication that is harvested by the work assignment mechanism 216 from a social media network or server 116. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the communication device 104 and the format of the communication. In particular, work items are logical representations within a contact center 106 of work to be performed in connection with servicing a communication received at contact center 106 (and, more specifically, the work assignment mechanism 216). The communication may be received and maintained at the work assignment mechanism 216, a switch or server connected to the work assignment mechanism 216, or the like, until a resource 212 is assigned to the work item representing that communication. At which point, the work assignment mechanism 216 passes the work item to a routing engine 232 to connect the communication device 104, which initiated the communication, with the assigned resource 212.

Although the routing engine 232 is depicted as being separate from the work assignment mechanism 216, the routing engine 232 may be incorporated into the work assignment mechanism 216 or its functionality may be executed by the work assignment engine 220.

In accordance with at least some embodiments of the present disclosure, the communication devices 104 may comprise any type of known communication equipment or collection of communication equipment. Examples of a suitable communication device 104 include, but are not limited to, a personal computer, laptop, Personal Digital Assistant (PDA), cellular phone, smart phone, telephone, or combinations thereof. In general, each communication device 104 may be adapted to support video, audio, text, and/or data communications with other communication devices 104 as well as the processing resources 212. The type of medium used by the communication device 104 to communicate with other communication devices 104 or processing resources 212 may depend upon the communication applications available on the communication device 104.

In accordance with at least some embodiments of the present disclosure, the work item is sent toward a collection of processing resources 212 via the combined efforts of the work assignment mechanism 216 and routing engine 232. The resources 212 can either be completely automated resources (e.g., Interactive Voice Response (IVR) units, microprocessors, servers, or the like), human resources utilizing communication devices, such as agent 112 utilizing agent terminal 110, or any other resource known to be used in contact center 106. While a human agent, such as agent 112, may provide certain inputs in certain embodiments, it should be appreciated that agent 112 may be omitted, such as to rely upon automated agent 108 entirely or in part. For example, many customers (e.g., user 102) may prefer, or are believed to prefer, to speak to a human and, therefore, agent 112 may be utilized to facilitate the communication. In such embodiments, agent 112 may provide inputs to agent terminal 110 or speak outputs from agent terminal 110.

As discussed above, the work assignment mechanism 216 and resources 212 may be owned and operated by a common entity in a contact center 106 format. In some embodiments, the work assignment mechanism 216 may be administered by multiple enterprises, each of which has its own dedicated resources 212 connected to the work assignment mechanism 216.

In some embodiments, the work assignment mechanism 216 comprises a work assignment engine 220, which enables the work assignment mechanism 216 to make intelligent routing decisions for work items. In some embodiments, the work assignment engine 220 is configured to administer and make work assignment decisions in a queueless contact center 106, as is described in U.S. patent application Ser. No. 12/882,950, the entire contents of which are hereby incorporated herein by reference. In other embodiments, the work assignment engine 220 may be configured to execute work assignment decisions in a traditional queue-based (or skill-based) contact center 102.

The work assignment engine 220 and its various components may reside in the work assignment mechanism 216 or in a number of different servers or processing devices. In some embodiments, cloud-based computing architectures can be employed whereby one or more components of the work assignment mechanism 216 are made available in a cloud or network such that they can be shared resources among a plurality of different users. Work assignment mechanism 216 may access customer database 218, such as to retrieve records, profiles, purchase history, previous work items, and/or other aspects of a customer known to contact center 106. Customer database 218 may be updated in response to a work item and/or input from resource 212 processing the work item.

It should be appreciated that one or more components of contact center 106 may be implemented in a cloud-based architecture in their entirety, or components thereof (e.g., hybrid), in addition to embodiments being entirely on-premises. In one embodiment, customer communication device 104 is connected to one of resources 212 via components entirely hosted by a cloud-based service provider, wherein processing and data storage elements may be dedicated to the operator of contact center 106 or shared or distributed amongst a plurality of service provider customers, one being contact center 106.

In one embodiment, a message is generated by customer communication device 104 and received, via first communication network 120, at work assignment mechanism 216. The message received by a contact center 106, such as at the work assignment mechanism 216, is generally, and herein, referred to as a “contact.” Routing engine 232 routes the contact to at least one of resources 212 for processing.

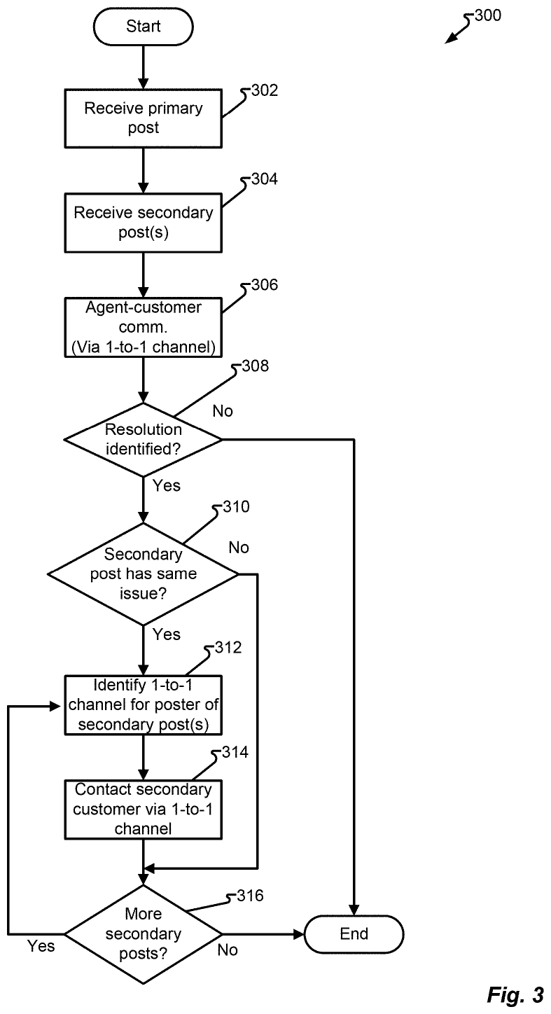

FIG. 3 depicts process 300 in accordance with embodiments of the present disclosure. In one embodiment, process 300 is performed by components of system 100 and/or system 200. In a further embodiment, a server, such as data processing server 124 which may be incorporated with or distinct from automated agent 108, monitors social media server 116 and, in step 302, receives a primary post. A primary post is a post on a social media website comprising content and which, in one embodiment, is a root message that is not an endorsement (e.g., a share, retweet, like, embellishment, etc.) of another post or, in another embodiment, contains a new issue unaddressed in a parent post. For example, a post may say, “I'm having problems with the motor on mine,” may be considered a primary post if it depends from a parent post stating “I just got my new washing machine,” as the two posts comprise different content.

In step 304, one or more secondary posts are provided to the primary posts. A secondary post is an endorsement of the primary post (e.g., a share, retweet, like, embellishment, etc.) of the primary post. For example, a primary post stating, “I'm having problems with the motor on my washing machine,” may have endorsements explicitly agreeing with the primary post or endorsements provided by social media website 114, such as “likes” and “shares,” or a secondary post may provide an embellishment (e.g., “the motor on mine makes a grinding noise,” “I agree,” “Have you tried kicking it?”). Step 304 may initiate the creation and/or routing of a work item, such as via work assignment mechanism 216, work assignment engine 220 and/or routing engine 232 and assigned to a particular resource 212, such as agent 112 or automated agent 108.

As is often the case with complex systems or solutions, or as a means to promote goodwill, information from the poster, user 102, a communication, such as to obtain additional information may be established, in order to resolve the issue or to execute an attempted resolution and determine whether or not the attempt was successful. If an attempt was not successful, additional attempted resolutions may be performed. Accordingly, in step 306, a second network topology is created by an ad-hoc network between contact center 106 and customer communication device 104 of user 102 that is devoid of social media website 114 or components thereof.

Test 308 determines if a resolution has been identified. In one embodiment, an automated component, such as one executing on automated agent 108 and/or data processing server 124, may monitor the communication, occurring thorough network 122, and determine if certain key words have been spoken or written, such as “that answers my question,” “that fixed,” “it's working now,” etc. as may be maintained in a data storage and cause test 308 to be answered in the affirmative. In contrast, a communication that ended without such words or phrases or indications to the contrary (e.g., “it still doesn't work,” “that didn't help,” etc.) may cause test 308 to be determined in the negative and process 300 to end. In such cases, other means to resolve the issue may be utilized.

Test 310 may be executed upon test 308 being determined in the affirmative. Test 310 determines if a primary post, as received or otherwise accessed in step 302, has at least one secondary post. If test 310 is determined in the negative, process 300 may continue at test 316 whereby test 316 determines if there are more secondary posts and, if yes, processing continues back to step 312. Similarly, if test 310 is determined in the affirmative, step 312 is the executed which identifies a 1-to-1 communication channel whereby the poster of the secondary post may be established as a node.

In another embodiment, test 310 may be embodied as a multi-option conditional statement. For example, primary post received in step 302 may be categorized by automated means and/or manual means (e.g., “washing machine problem=C1”, “Sales inquiry=C2,” “General comment=C3,” etc.). Then, test 310 may determine if a secondary post matches one of the existing categories. Steps 312, 314, and 316 may then be performed on a per-category basis. In another embodiment, if the secondary post 310 is determined to be directed to a different issue, such as, “I have a question about my bill,” when the primary post in step 302 is related to washing machine motors, may be considered to be a new primary post as received at step 302.

Step 314 then contacts the poster of the secondary post and delivers a resolution. The resolution may be, or start, as a candidate resolution (e.g., comprising certain facts, actions, explanations, etc.) that are known, by test 308, to resolve the issue present in the primary post, received in step 302. The candidate resolution may then be generated to comprise the candidate resolution and be in a format for delivery via the ad-hoc network between the user providing the secondary post and comprising, as the other node, a component of contact center 106, such as automated agent 108 or agent terminal 110. For example, a candidate resolution may comprise a text or spoken form of the resolution (e.g., “tighten the screw that adjusts tension on the belt”) and, from that, a final resolution may comprise a generated speech and associated number to dial to deliver a spoken message via a POTS network. Additionally or alternatively, an email may be formatted with the proper email headers and formatting for delivery via a network, and receivable by a customer communication device 104, operable to facilitate email communications.

Process 300 may then re-execute test 316 such as to repeat steps 312 and 314 for the next user associated with another secondary post. Once no more secondary posts remain unprocessed, test 316 is determined in the negative and process 300 may end or be re-executed upon receiving a new post at step 302. Accordingly, process 300 may execute on demand, periodically, or continually.

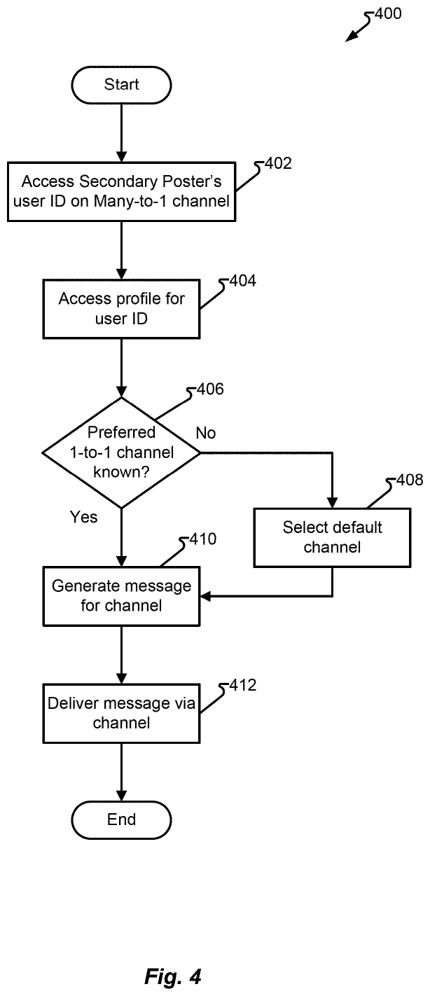

FIG. 4 depicts process 400 in accordance with embodiments of the present disclosure. In one embodiment, process 400 executes steps in lieu of steps 312 and 314 of process 300. Step 402 accesses a data storage to access the user identifier utilized on social media website 114 providing a secondary post. Step 404 accesses a user profile for the user identifier of the user providing the secondary post. Test 406 determines if a preferred communication channel for 1-to-1 communications is known for the user and, if yes, process 400 continues to step 410. If test 406 is determined in the negative, then step 408 is executed whereby a default communication channel is identified. For example, certain social media website 114 (e.g., Facebook, Twitter, etc.) have a private messaging service, which may be considered the default communication channel for secondary posts on the same social media website 114. In another embodiment, a user may be known in customer database 218 and the preferred channel determined from an entry therein. In another embodiment, a user may be known in social media server 118 and a preferred channel determined from an entry therein.

Step 410 generates a message for the channel selected, either the preferred channel or the default channel, as determined by test 406. For example, automated agent 108 and/or data processing server 124 may generate a text message for automated agent 108 to deliver via a text channel. Alternatively, automated agent 108 and/or data processing server 124 may generate a text message for automated agent 108 to deliver via a voice channel. Header information (e.g., recipient address, subject, etc.) may also be utilized for emails. Then, step 412 creates the ad-hoc 1-to-1 network between automated agent 108 and customer communication device 104 (selected in accordance with the preferred or default communication channel) and delivers the message thereon.

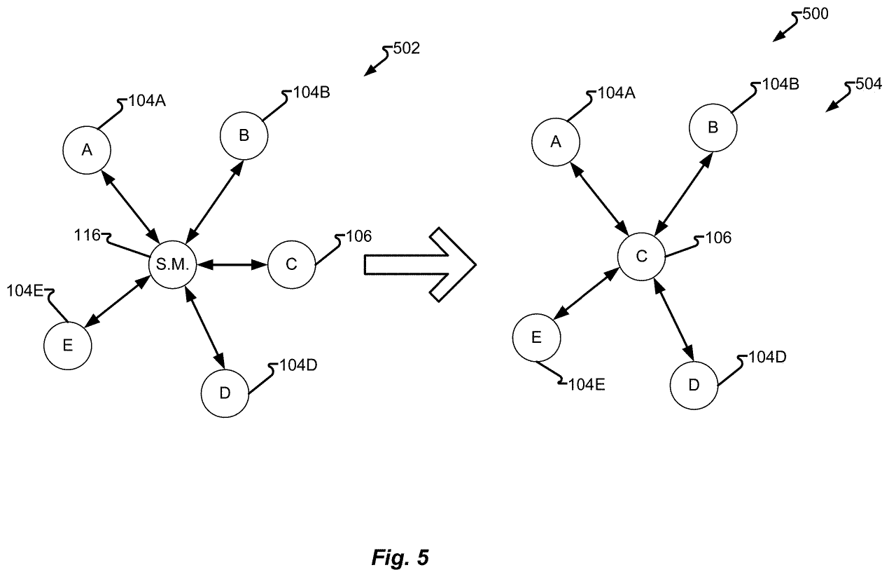

FIG. 5 depicts network topology change 500 in accordance with embodiments of the present disclosure. In one embodiment, many-to-many network 502 is provided comprising at least two nodes, which may comprise at least one customer communication device 104 (e.g., customer communication device 104A-D) and at least one component of contact center 106 (e.g., agent terminal 110 or automated agent 108). All communications between nodes pass through social media server 116 which is the hub of network 502.

In one embodiment, network 502 is modified to become network 504 and exclude node provided by social media server 116 and thereby establish a number of 1-to-1 ad-hoc networks, such as with node 106 (contact center 106) and node 104A (customer communication device 104A), another ad-hoc 1-to-one network may be formed with node 106 (contact center 106) and node 104B (customer communication device 104B), another ad-hoc 1-to-one network may be formed with node 106 (contact center 106) and node 104D (customer communication device 104D), and another ad-hoc 1-to-one network may be formed with node 106 (contact center 106) and node 104E (customer communication device 104E), as necessary. In one embodiment, social media server 116 is entirely absent network 504.

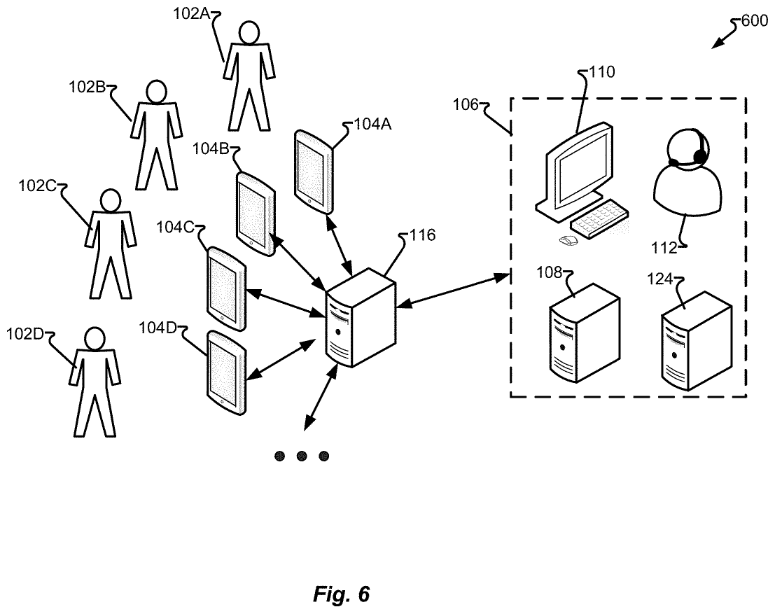

FIG. 6 depicts network topology 600 in accordance with embodiments of the present disclosure. Network topology 600 generally resembles network 502 with social media server 116 as the hub and all node-to-node communications (between one or more customer communication device 104 and/or contact center 106) including social media server 116. In one embodiment a primary post is provided by user 102A via customer communication device 104A on social media server 116.

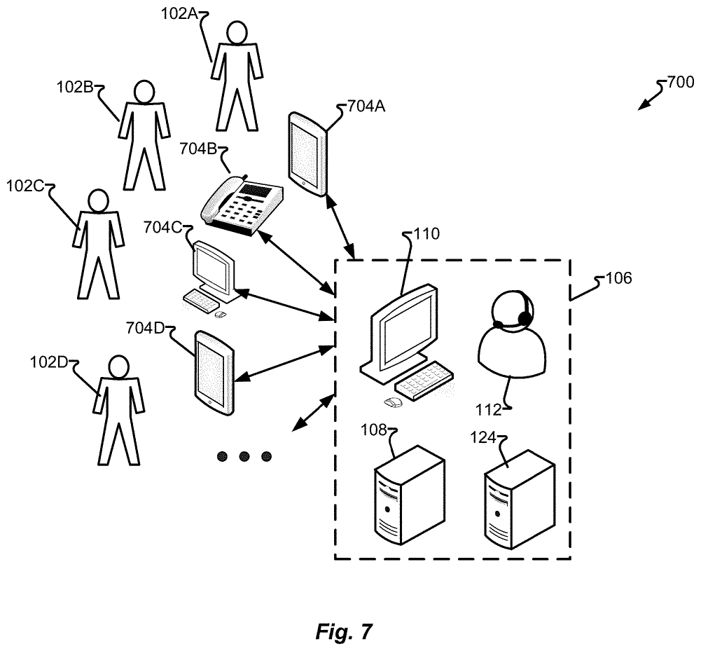

FIG. 7 depicts network topology 700 in accordance with embodiments of the present disclosure. In one embodiment, network topology 700 generally resembles network 504. Network topology 504 facilitates node-to-node communications (between ones of customer communication device 104 and contact center 106) to omit social media server 116 or any portion of social media website 114. Accordingly, a number of ad-hoc one-to-one networks are established, each comprising contact center 106 as one node and one of customer communication devices 704 specific for a particular channel and user 102. For example, one 1-to-1 network comprises customer communication device 704A associated with user 102A and automated agent 108 of contact center 106, such as to provide a message comprising a resolution for an issue that user 102A originated a secondary post, such as via a text message format and network (e.g., second network 122 when embodied as a network facilitating text messaging). Another network comprises contact center 106 and customer communication device 704B (POTS telephone) associated with user 102B, such as to provide a resolution a resolution for an issue that user 102A originated a secondary post, such as via a text message format and network (e.g., second network 122 when embodied as a POTS telephony network). Similarly, 1-to-1 networks may be created between contact center 106 and ones of customer communication device 704C (a computer supporting multiple protocols and/or network connectivity) and between contact center 106 and customer communication device 704D (a smart phone supporting multiple protocols and/or network connectivity).

In another embodiment, at least one of users 102A-D, via their respective customer communication device 704 (each being a particular embodiment of customer communication device 104 and associated with one of users 102A-D) may have a message formatted by data processing server 124 and delivered via automated agent 108 via a respective second network 122.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose microprocessor (e.g., GPU, CPU), or logic circuits programmed with the instructions to perform the methods (e.g., FPGA). In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for conducting communications via a plurality of networks, comprising:
a network interface to at least one network; and
a microprocessor having a memory for storage of instructions that cause the microprocessor to:
receiving, from a first user communication device of a first user, a first message on a first communication channel;
receiving, from a second user communication device of a second user, a second message in response to the first message, the second message endorsing the content of the first message;
determining a candidate resolution to the first message;
connecting a resource to a third communication device of the first user and providing the candidate resolution via a second communication channel; and
upon determining the candidate resolution resolved an issue presented in the first message, generating a final resolution from the candidate resolution for a third communication channel and causing a communication agent to connect via the third communication channel to deliver the final resolution to a fourth communication device of the second user.

2. The system of claim 1, wherein the first communication device of the first user and the third communication device of the first user are the same communication device.

3. The system of claim 1, wherein the second user communication device and the fourth communication device of the second user are the same communication device.

4. The system of claim 3, wherein the same communication device comprises the second communication device, operable to communicate via a first communication protocol, and the same communication device further comprises, the fourth communication device, operable to communicate via a second communication protocol.

5. The system of claim 4, wherein the first communication protocol further utilizes a first network and the second communication protocol further utilizes a second communication network different from the first communication network.

6. The system of claim 4, wherein the microprocessor further generates the final resolution to comprise a format in accordance with the second communication protocol.

7. The system of claim 1, wherein the instructions further cause the microprocessor to enqueue the third communication in a queue of an automated agent allocated to connect the microprocessor with the fourth communication device communicate therebetween comprising the final resolution.

8. The system of claim 1, further comprising instructions to cause the microprocessor to perform generating the final resolution from the candidate resolution for the third communication channel in a first message format in accordance with the third communication channel.

9. The system of claim 1, wherein the instructions further cause the microprocessor to:
receiving, from a fifth user communication device of a third user, a third message in response to the first message, the third message endorsing the content of the first message; and
upon determining the candidate resolution resolved the issue presented in the first message, generating a second final resolution from the candidate resolution for a fourth communication channel and causing the communication agent to connect via the fourth communication channel to deliver the final resolution to a sixth communication device of the second user.

10. The system of claim 9, wherein the fifth communication device and the sixth communication device are the same communication device.

11. The system of claim 10, wherein the same communication device comprises the fifth communication device, operable to communicate via a first communication protocol, and the same communication device further comprises, the sixth communication device, operable to communicate via a second communication protocol.

12. A method for conducting communications via a plurality of networks, comprising:
receiving, from a first user communication device of a first user, a first message on a first communication channel;
receiving, from a second user communication device of a second user, a second message in response to the first message, the second message endorsing the content of the first message;
determining a candidate resolution to the first message;
connecting a resource to a third communication device of the first user and providing the candidate resolution via a second communication channel; and
upon determining the candidate resolution resolved an issue presented in the first message, generating a final resolution from the candidate resolution for a third communication channel and causing a communication agent to connect via the third communication channel to deliver the final resolution to a fourth communication device of the second user.

13. The method of claim 12, wherein the first communication device of the first user and the third communication device of the first user are the same communication device.

14. The method of claim 12, wherein the second user communication device and the fourth communication device of the second user are the same communication device.

15. The method of claim 14, wherein the same communication device comprises the second communication device, operable to communicate via a first communication protocol, and the same communication device further comprises, the fourth communication device, operable to communicate via a second communication protocol.

16. The method of claim 15, wherein the first communication protocol further utilizes a first network and the second communication protocol further utilizes a second communication network different from the first communication network.

17. The method of claim 15, wherein generating the final resolution further comprises generating the final solution to comprise a format in accordance with the second communication protocol.

18. The method of claim 12, further comprising enqueuing the third communication in a queue of an automated agent allocated to connect the microprocessor with the fourth communication device communicate therebetween comprising the final resolution.

19. The method of claim 12, further comprising generating the final resolution from the candidate resolution for the third communication channel in a first message format in accordance with the third communication channel.

20. A server, comprising:
a network interface to at least one network; and
a microprocessor having a memory for storage of instructions that cause the microprocessor to:
monitor a message thread on a social media website;
determine a message on the message thread comprises an issue relevant to a domain of interest and was posted by a root user;
determining a second message on the message thread endorses the content of the message and was posted by a secondary user;
connecting a resource to a first communication device of the root user for a first communication; and
upon determining the first communication comprises a candidate resolution to an issue in the message, automatically and without human intervention, formatting a final resolution in accordance with the candidate resolution protocol and further in accordance with a communication channel associated with a secondary communication device associated with the secondary user and communicating the final resolution to the secondary device via the communication channel.
